(19) United States
(12) Patent Application Publication
(10) Pub. No.: US 2009/0050735 A1
(43) Pub. Date: Feb. 26, 2009

(54) SYSTEMS AND METHODS RELATED TO ELECTROMAGNETIC ENERGY DISSIPATION

(75) Inventor: Thomas J. Sobol, Woodland Hills, CA (US)

Correspondence Address: PERKINS COIE LLP;PATENT-SEA, P.O. BOX 1247, SEATTLE, WA, 98111-1247, US

(73) Assignee: Kirkhill-TA Co., Valencia, CA (US)

(21) Appl. No.: 11/844,654

(22) Filed: Aug. 24, 2007

(51) Int. Cl. B64D 45/02; B21D 53/88; H01B 5/14

(52) U.S. Cl. 244/1 A; 174/126.4; 29/897.2

(57) ABSTRACT

Embodiments of the present invention relate generally to systems and methods related to electromagnetic energy dissipation, including the dissipation of static electricity. One aspect of the invention is directed toward an electromagnetic dissipation system that includes a conductive material, a protective element, and a base element. The conductive material is coupled between a portion of the outer surface of the protective element and a portion of the outer surface of the base element to form a modular dissipation system. Other aspects of the invention are directed toward a vehicle system that includes a receiving surface, a conductive element, and a protective element. The conductive element is (a) coupled between a portion of the receiving surface of the vehicle and a portion of the outer surface of the protective element, and/or (b) embedded in the portion of the receiving surface.

### TECHNICAL FIELD

Embodiments of the present invention relate generally to systems and methods related to electromagnetic energy dissipation, for example, an electromagnetic dissipation system for dissipating static electricity generated by the motion of an aerospace vehicle through an air mass.

### BACKGROUND

During flight, aircraft can accumulate a static electricity charge on leading edge surfaces due to the air flowing over these surfaces. This condition often occurs when the aircraft flies through an air mass containing higher levels of moisture or particulate matter. For example, the tendency to accumulate a static charge can increase when the air mass carries high levels of humidity; carries visible moisture such as clouds, fog or ice crystals; or carries particulate matter such as dust or volcanic ash. This build up of static electricity on an aerospace vehicle is sometimes referred to as precipitation static or P-static. In some cases where an aircraft does not include appropriately placed conductive paths such as bonding between surfaces, P-static build up and discharge can cause adverse effects to the aircraft or electromagnetic interference (EMI) with aircraft systems.

Additionally, some aircraft require a rain erosion tape to be carried on some of the leading edge surfaces of the aircraft to prevent an adverse effect from precipitation or ice crystals impacting the leading edge surfaces during flight through precipitation or icing conditions. This tape is generally replaced when it becomes worn. In some cases, after the tape is installed on the aircraft, the exposed surface of the tape is coated with an electrostatic coating that provides an electrical path to a ground plane in the vehicle to aid in the dissipation of P-static. In some cases, a portion of this coating wears off during flight and must be reapplied before the next flight. In other cases, the remaining portions of the coating must be removed after flight and a new coating applied to provide adequate and consistent static electricity dissipation performance during subsequent flights.

### BRIEF DESCRIPTION OF THE DRAWINGS

FIG. 1 is a partially schematic plan view of a vehicle system in accordance with embodiments of the invention.

FIG. 2 is a partially schematic plan view of a portion of an electromagnetic dissipation system of the vehicle system shown in FIG. 1 in accordance with selected embodiments of the invention.

FIG. 3 is a partially schematic cross-sectional side elevation view of a portion of the electromagnetic dissipation system shown in FIG. 2 taken along line 3-3.

FIG. 4 is a partially schematic plan view of a carrier element of the dissipation system shown in FIG. 3 in accordance with certain embodiments of the invention.

FIG. 5 is an isometric illustration of a portion of a receiving surface of the vehicle system shown in FIG. 1.

FIG. 6 is a partially schematic cross-sectional side elevation view of the electromagnetic dissipation system shown in FIG. 2 coupled to the receiving surface shown in FIG. 5 in accordance with selected embodiments of the invention.

FIG. 7 is a partially schematic cross-sectional elevation view of an electromagnetic dissipation system in accordance with other embodiments of the invention.

### DETAILED DESCRIPTION

Embodiments of the present invention relate generally to systems and methods related to electromagnetic energy dissipation. One aspect of the invention is directed toward an electromagnetic dissipation system that includes a conductive material and a protective element having an outer surface and an inner surface at least approximately opposite the outer surface of the protective element. The system further includes a base element having an outer surface and an inner surface at least approximately opposite the outer surface of the base element. A portion of the inner surface of the protective element is positioned to at least approximately face a portion of the inner surface of the base element. The conductive material is coupled between the portion of the outer surface of the protective element and the portion of the outer surface of the base element to form a modular dissipation system that is attachable to a receiving surface with the portion of the outer surface of the base element at least approximately facing the receiving surface.

Other aspects of the invention are directed toward a method for making an electromagnetic dissipation system that includes providing a conductive material and providing a protective element having an outer surface and an inner surface at least approximately opposite the outer surface of the protective element. The method further includes providing a base element having an outer surface and an inner surface at least approximately opposite the outer surface of the base element. The method still further includes coupling the conductive material between a portion of the outer surface of the protective element and a portion of the outer surface of the base element with the portion of the inner surface of the protective element positioned to at least approximately face the portion of the inner surface of the base element to form a modular dissipation system that is attachable to a receiving surface with the portion of the outer surface of the base element at least approximately facing the receiving surface.

Still other aspects of the invention are directed toward a vehicle system that includes a vehicle having a receiving surface and a conductive element that includes a low conductance carrier element combined with a conductive material that includes a conductive polymer. The system further includes a protective element having an outer surface and an inner surface at least approximately opposite the outer surface of the protective element. A portion of the inner surface of the protective element is positioned to at least approximately face a portion of the receiving surface of the vehicle. The conductive element is (a) coupled between the portion of the receiving surface of the vehicle and the portion of the outer surface of the protective element, and/or (b) embedded in the portion of the receiving surface.

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section. Additionally, as used herein, the term electromagnetic energy includes all forms of electromagnetic energy including electricity; electrical fields; electrical charges; magnetic fields; electromagnetic radiation including various wavelengths of light, RADAR, microwaves; and/or the like.

References throughout the specification to “one embodiment” or “an embodiment” means that a particular feature, structure, or characteristic described in connection with the embodiment and included in at least one embodiment of the present invention. Thus, the appearances of the phrase “in one embodiment” or “in an embodiment” in various places throughout the specification are not necessarily all referring to the same embodiment. Furthermore, the particular features, structures, or characteristics may be combined in any suitable manner in one or more embodiments.

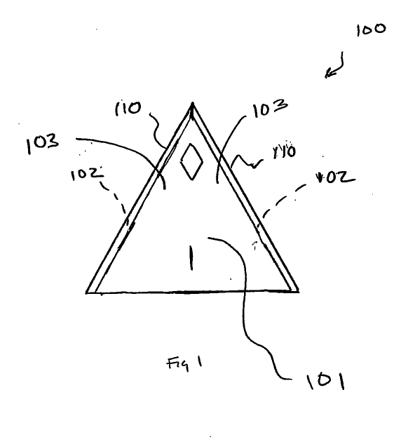

FIG. 1 is a partially schematic plan view of a vehicle system 100 in accordance with embodiments of the invention. In FIG. 1, the vehicle system includes multiple dissipation systems 110 (e.g., electromagnetic dissipation systems) on multiple receiving surfaces 102 of the vehicle 101, such as an aerospace vehicle. In the illustrated embodiment, the dissipation system 110 is configured to dissipate static electricity (or other types of electromagnetic energy) that accumulates on an exposed surface of the dissipation system 110 and/or other portions of the aerospace vehicle (e.g., surface portions proximate to the dissipation system 110). For example, the dissipation system 110 can be positioned so a static charge on, or proximate to, the dissipation system 110 is carried to a dissipation point (e.g., a portion of the vehicle that acts as, or is connected to, a ground plane) at a rate that will reduce the potential for adverse effects to the vehicle system or the potential for EMI with vehicle systems. Additionally, in FIG. 1 the dissipation system 110 is configured to be at least approximately invisible to selected frequency of electromagnetic radiation (e.g., selected frequency of radiated electromagnetic energy such as RADAR energy, microwave energy, and/or the like).

The dissipation system 110 in FIG. 1 also includes a protective element that provides erosion protection from participation, icing, particulate matter, and/or the like. In selected embodiments, this protective element, as positioned on the receiving surfaces 102, can include an exposed surface with a dull finish to reduce the reflection of selected frequencies of electromagnetic radiation such as visible light, infrared light, and/or the like. In still other embodiments, the protective element can carry a color pigment and/or be coated with a coating material such as paint to provide a selected color scheme and/or other characteristics.

In other embodiments, the vehicle system 100 can include more, fewer, and/or different dissipation systems. For example, in selected embodiments one or more of the dissipation systems 110 can include more, fewer, and/or different features than those discussed above with reference to FIG. 1. Additionally, although the receiving surfaces 102 in FIG. 1 are shown as the leading edges of airfoils 103 on an aerospace vehicle, in other embodiments the receiving surfaces can include other types of surfaces, surfaces on other types of vehicles, and/or surfaces on other structures.

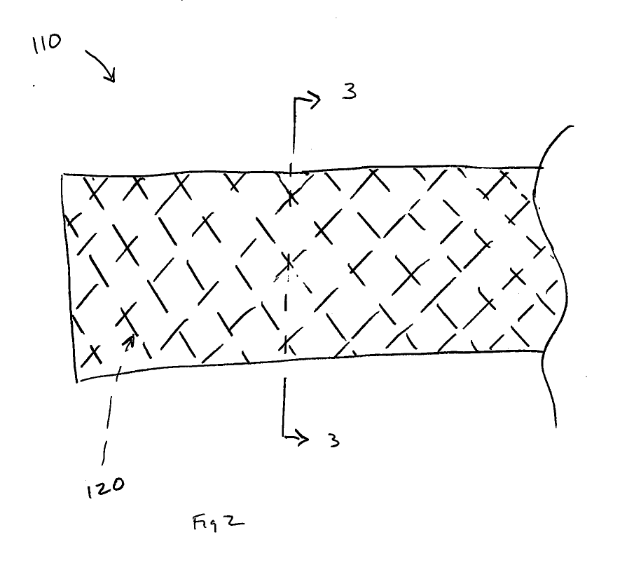

In FIG. 1, the receiving surfaces 102 include portions of the leading edge of the vehicle's airfoil 103 and the dissipation systems 110 include tape-like structures that are coupled or attached to the receiving surfaces 102. For example, FIG. 2 is a partially schematic plan view of a portion of one of the electromagnetic dissipation systems 110 before it has been applied to one of the receiving surfaces 102. In the illustrated embodiment, the dissipation system 110 can be flexible so that it can conform to the receiving surface 102. In other embodiments, the dissipation system 110 can be substantially stiff or rigid.

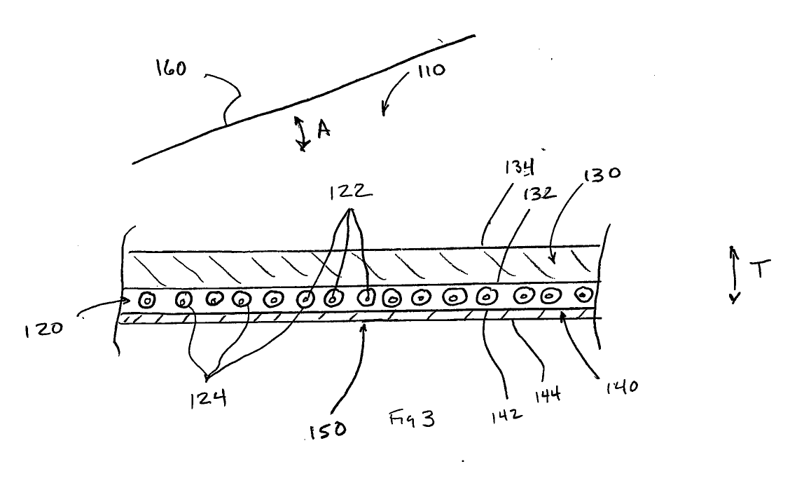

FIG. 3 is a partially schematic cross-sectional side elevation view of a portion of the electromagnetic dissipation system 110 shown in FIG. 2 taken along line 3-3. In the illustrated embodiment, the dissipation system 110 can include a conductive element 120, a protective element 130, and a base element 140. In FIG. 3, the protective element 130 includes an outer surface 134 and an inner surface 132 that is at least approximately opposite the outer surface 134. The base element 140 (discussed in greater detail below) also has an outer surface 144 and an inner surface 142 at least approximately opposite the outer surface 144.

In the illustrated embodiment, a portion of the inner surface 132 of the protective element 130 is positioned to at least approximately face a portion of the inner surface 142 of the base element 140. In FIG. 3, the conductive element 120 is coupled between the portion of the outer surface 134 of the protective element 130 and the portion of the outer surface 144 of the base element 140 to form a dissipation system 110 that is modular and attachable to one of the receiving surfaces 102 (FIG. 1) with the portion of the outer surface 144 of the base element 140 at least approximately facing the receiving surface 102. For example, in selected embodiments at least part of the outer surface 144 of the base element 140 can carry an adhesive 150 configured to attach the outer surface 144 of the base element 140 to one of the receiving surfaces 102 (FIG. 1), thereby attaching the dissipation system 110 to the receiving surface. In other embodiments, the dissipation system 110 can be attached using other methods. For example, the dissipation system 110 can be attached to one of the receiving surfaces 102 (FIG. 1) using one or more fasteners (e.g., rivets, bolts, screws, etc.), and/or an adhesive can be placed on a portion of the receiving surface 102 and the dissipation system 110 can be positioned on the adhesive and the receiving surface 102.

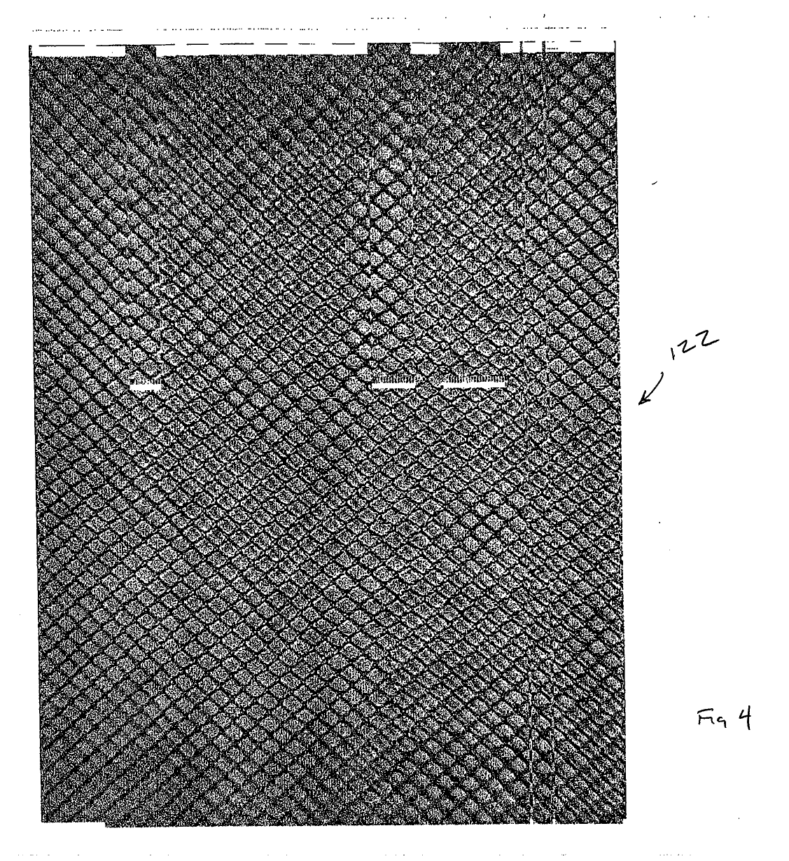

In FIG. 3, the conductive element 120 includes a carrier element 122 combined with a conductive material 124. The carrier element 122 can include a low or non conductive flexible material such as a scrim fabric having a balanced weave (as shown in FIG. 4), a nylon scrim fabric having a balanced weave, and/or a tricot knit fabric having a balanced weave. In FIG. 3, the carrier element 122 has been coated with and/or has absorbed the conductive material 124 (e.g., the carrier element 122 has been combined with the conductive material 124). In selected embodiments the conductive material 124 can include a non-metallic material such as a conductive plastic or conductive polymer. For instance, the conductive material 124 can include carbon black, polyaniline, and/or polypyrrole. One such conductive material includes an intrinsically conductive polymer called Eeonomer available from Eeonyx Corporation of Pinole, Calif. In selected embodiments, the deposition process of the conductive material 124 onto/into the carrier element 122 can be varied to provide a selected resistance and/or impedance characteristic so that the dissipation system 110 can achieve a selected build up and dissipation of expected static electrical charges on, or proximate to, the dissipation system 110. For example, in certain embodiments the dissipation system 110 can be configured to have a surface resistance of 0.5 to 25 mega ohms per unit area (e.g., square inch, square foot, and/or the like).

In the illustrated embodiment, the dissipation system 110, with the conductive element 120, can be configured to be at least approximately invisible to selected frequencies of radiated electromagnetic energy, such as microwave or RADAR energy. In selected embodiments where the carrier element 122 carrying the conductive material 124 has at least approximately equal filament spacing in one or more directions, the conductive element 120 can provide selected return characteristics when illuminated by the electromagnetic radiation from one or more selected directions. For instance, the conductive element 120 can be configured to provide reduced or low reflectivity for selected wave lengths of radiated electromagnetic energy, to scatter radiated electromagnetic energy, and/or to provide a constant return of radiated electromagnetic energy without areas of concentration (e.g., without returning “spikes” or “bright areas”) when illuminated by the radiated electromagnetic energy from one or more selected directions. In some embodiments, this feature can render the dissipation system 110 at least approximately invisible to selected frequencies of electromagnetic radiation.

In other embodiments, the conductive element 120 can have more, fewer, and/or different elements or components. For example, in selected embodiments the conductive element can include a carrier element 122 and a conductive material 124 that are combined in other manners, for example, using various types of deposition processes. In the illustrated embodiment the conductive element 120 does not include any metallic materials (e.g., as chemically defined). In other embodiments, however, the conductive element 120 can include at least one metal. In selected embodiments, the conductive element 120 can be made entirely of the conductive material 124 and does not include a carrier element 122. For example, in selected embodiments the conductive element can be formed from a conductive plastic or conductive polymer and does not include a carrier element. In other embodiments, the conductive element can be made from a metallic conductive material (e.g., a metallic mesh). In certain embodiments, the conductive element can be flexible, while in other embodiments the conductive element can be substantially stiff or rigid.

In selected embodiments, the protective element 130 can include a material that is configured to protect at least a portion of the conductive element 120 and/or a portion of the receiving surface 102 (FIG. 1) from environmental conditions such as rain, icing conditions, and particulate matter present in the air mass. Additionally, in certain embodiments the protective element 130 can have good durability characteristics to protect the conductive element 120 and/or the portion of the receiving surface 102 (FIG. 1) for an extended period of time without having to be replaced (e.g., replaced less often than the protective tape used to protect the leading edges of current aircraft). In selected embodiments, the protective element 130 can include a plastic, a rubber, a thermoplastic, a heat curable compound, a urethane elastomer, and/or a polyurethane material, polymer, or compound. For example, one such polyurethane polymer includes a polyurethane based compound EF60L6816 available from Kirkhill Elastomers of Brea, Calif. In some embodiments, the protected element can be flexible, while in other embodiments the protective element can be rigid.

In certain embodiments, the protective element 130 can have selected electromagnetic characteristics. For example, the protective element 130 can be configured to have low or no electrical conductivity and/or low or no reflectivity with respect to selected frequencies of radiated electromagnetic energy. Additionally, in certain embodiments the protective element 130 can carry a colored pigment or other colored material, for example, to match the color or color pattern of a portion of the receiving surface 102. In other embodiments, at least part of the outer surface 134 of the protective element 130 can be painted or coated (e.g., with a coating that has low conductivity or low reflectivity with respect to a selected range of electromagnetic radiation).

In still other embodiments, the protective element 130 can be configured so that its outer surface 134 (e.g., the exposed surface in the illustrated embodiment) is dull. In selected embodiments the outer surface 134 of the protective element 130 can be configured to diffuse, or have a low reflectivity with respect to selected frequencies of electromagnetic radiation (e.g., visible light, infrared light, etc.). For example, a forming material 160 having a selected surface roughness or surface pattern can be pressed onto at least part of the outer surface 134 of the protective element 130 and removed (as shown by arrows A) to configure the part of the outer surface to be dull (e.g., having low or no reflectivity or reflectance with respect to electromagnetic radiation). For example, in certain embodiments a portion of the protective element 130 can be pressed onto the forming material 160 while the portion of the protective element is at a selected temperature and/or pressure. One such forming material can include a cellulose film having at least one rough surface such as Kodacel that is available from the Eastman Kodak Company of Rochester, N.Y. In other embodiments, a coating can be applied to at least part of the outer surface 134 of the protective element 130 to cover or dull the part of the outer surface.

In the illustrated embodiment, the base element 140 includes a material suitable for coupling to the conductive element 120 and/or to the protect element 130, and for coupling the dissipation system 110 to one of the receiving surfaces 102 (FIG. 1). The base element 140 can be configured to have a selected level of conductivity depending, at least in part, on the configuration of the conductive element 120 and the conductivity of a dissipation point on the receiving surface (discussed below in greater detail). As discussed above, in selected embodiments the base element 140 can carry an adhesive 150 on its outer surface 144 suitable for coupling or attaching the dissipation system 110 to at least a portion of one of the receiving surfaces 102 (FIG. 1). For example, a primer or adhesion promoter can be applied to a portion of the receiving surface 102 and the dissipation system 110 can be mounted to the receiving surface via the adhesive 150 on the outer surface 144 of the base element 140. In other embodiments, the base element 140 does not carry or include an adhesive and other methods are used to attach the dissipation system 110 to the receiving surface.

In yet other embodiments, the base element 140 can include, or be solely comprised of, an adhesive. For example, in one embodiment the base element 140 can be an adhesive layer coupled to the conductive element 120 and/or the protective element 130. The outer surface 144 or exposed surface of the adhesive layer can then be used to attach the dissipation system to one of the receiving surfaces 102 (FIG. 1). In selected embodiments, an adhesive suitable for use with some of the embodiments discussed above includes an adhesive that can be applied from a pressure sensitive acrylic or cyanocrylate transfer tape such a 3M Adhesive Transfer tape 467 available from the 3M Corporation of St. Paul, Minn.

In one embodiment a dissipation system 110 can be formed by coating a carrier element 122 that includes a scrim fabric with a conductive material 124 that includes an intrinsically conductive polymer to form a conductive element 120. Using a rubber calender, a polyurethane based compound can be deposited (e.g., pressed) onto a forming surface that includes the rough side, or surface, of a cellulose film to at least partially form the protective element 130. A rotocure device can then be used to mold the conductive element 120 with the protective element 130 so that the conductive element 120 is opposite the cellulose film.

The cellulose film can then be removed leaving a protective element 130 having an outer surface 134 that is at least approximately 0.007 inches from the conductive element 120 (e.g., in the direction of arrows T). Additionally, because of the rough surface of the forming element 160, the outer surface 134 of the protective element 130 can be dull. The base element 140 can include an adhesive and can be applied to a portion of the conductive element 120 and/or a portion of the protective element 130 via a pressure sensitive transfer tape on a backing. In selected embodiments, the adhesive can be at least approximately 0.002 to 0.005 inches thick (e.g., in the direction of arrows T) and the dissipation system 110 (including the protective element 130, conductive element 120, and base element 140) can be at least approximately 0.014 inches thick. Accordingly, when the dissipation system 110 is coupled to one of the receiving surfaces 102 (FIG. 1) the conductive element 120 can be at least approximately within 0.007 inches of the receiving surface 102 and/or a dissipation point on the receiving surface 102.

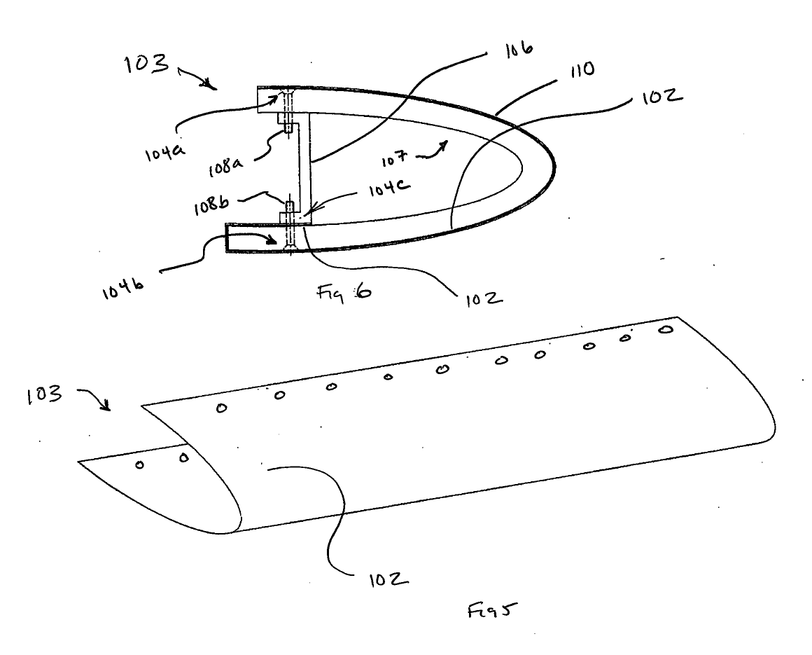

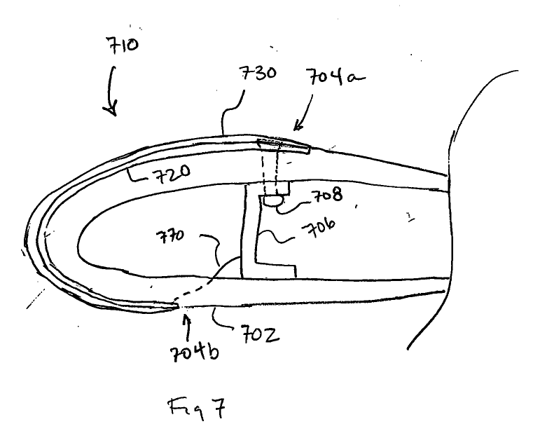

FIG. 5 is an isometric illustration of a portion of the receiving surface 102 of the vehicle system 100 shown in FIG. 1. In the illustrated embodiment, the receiving surface 102 includes a portion of a leading edge of an airfoil 103 that is couplable to a metal spar or other conductive portion of the vehicle system 100 (FIG. 1) that forms a ground plane for the vehicle system 100. FIG. 6 is a partially schematic cross-sectional side elevation view of the electromagnetic dissipation system 110 shown in FIGS. 1-3 coupled to the receiving surface 102 shown in FIGS. 1 and 5 in accordance with selected embodiments of the invention. In FIG. 6, the receiving surface 102 is coupled to a conductive portion 106 of the vehicle system 100 (e.g., a metallic spar) via one or more fasteners 108, shown in FIG. 6 as a first fastener 108a and a second fastener 108b. The conductive portion 106 of the vehicle system 100 in FIG. 6 is associated with the receiving surface 102 because it is positioned and configured to receive electromagnetic energy (e.g., electricity) from the receiving surface 102 and/or the dissipation system 110 associated with, coupled to, or carried by the receiving surface 102.

In the illustrated embodiment, there are one or more dissipation points 104 associated with the receiving surface 102, shown as a first dissipation point 104a, a second dissipation point 104b, and third dissipation point(s) 104c. In FIG. 6, the dissipation points associated with the receiving surface are configured to carry electromagnetic energy (e.g., electrical energy) from the receiving surface 102 and/or the dissipation system 110 associated with, coupled to, or carried by the receiving surface 102 to the conductive portion 106. The conductive portion 106 in FIG. 6 serves as a grounding plane or a conduit to a grounding plane for the vehicle system 100. In the illustrated embodiment, the first and second fasteners 108a and 108b are made from a conductive material and positioned to be in electrical contact with the conductive portion 106. Accordingly, in FIG. 6, portions of the first and second fasteners 108a and 108b are proximate to, or on, the receiving surface 102 and form the first and second dissipation points 104a and 104b. In FIG. 6, the receiving surface 102 continues around the inside of the leading edge and third dissipation point(s) 104c are formed by the combination of the conductive portion 106 and the second fastener 108b. In other embodiments, the vehicle system can have more, fewer, or different dissipation points.

In the illustrated embodiment, the dissipation system 110 has been conformed to, or around, a portion of the receiving surface 102 and coupled to the receiving surface via the base element 140 (shown in FIG. 4) with at least a portion of the outer surface 134 of the protective element 130 exposed. In FIG. 6, the dissipation system 110 is positioned proximate to, or over, the first and second dissipation points 104a and 104b. In selected embodiments, as static electricity accumulates on the outer surface 134 of the protective element 130 (shown in FIG. 4), the conductive element 120 can allow the static electricity to pass to the first and second dissipation points 104a and 104b even though the conductive element 120 is not in direct contact with the exposed or outer surface 134 of the protective element 130 and/or in direct contact with the first or second dissipation points 104a or 104b.

In certain embodiments, the dissipation of the static electricity is accomplished via the interaction of an electric field created on the protective element 130 with the conductive element 120 (e.g., via induction) and the interaction of the electric field created by the conductive element 120 with at least one of the first and second dissipation points 104a and 104b. In other embodiments, electricity can flow through the protective element 130 (e.g., via conductance) to the conductive element 120 and from the conductive element 120 though the base element 140 to at least one of the first and second dissipation points 104a and 104b. In other embodiments, static electricity can be dissipated from the outer surface 134 of the protective element 130 to, or through, the dissipation points via a combination of the two processes described above and/or via other processes.

The dissipation system 110 can be configured to provide one or more selected characteristics, such as a selected static electricity dissipation rate and/or a selected electromagnetic radiation reflectivity characteristic. For example, the type and arrangement of materials used to construct the protective element 130, the conductive element 120, and/or the base element 140 can be selected to provide one or more selected electromagnetic characteristics such as electromagnetic energy conductivity, electromagnetic radiation reflectivity, and/or the like. Accordingly, the dissipation system 110 can be configured to meet selected operational characteristics for a selected vehicle design.

In FIG. 6, a portion of the dissipation system 110 is coupled between the conductive portion 106 of the vehicle system 100 and the receiving surface 102. The second fastener 108b extends through the portion of the dissipation system 110. Accordingly, a portion of the second fastener 108b is in direct contact with the protective element 130, the conductive element 120, and the base element 140. Additionally, in FIG. 6 the outer surface 134 of the protective element 130 of the dissipation system 110 is proximate to, or in contact with, the conductive portion 106 of the vehicle system 100. In the illustrated embodiment, one or more third dissipation points 104c are formed by the direct contact of the second fastener with the protective element 130, the conductive element 120, and/or the base element 140; and/or by the proximity of the dissipation system to the conductive portion 106 of the vehicle system 100. As discussed above, accumulated static electricity can be passed from the dissipation system 110 to the third dissipation point by various processes including inductance and/or conductance.

In other embodiments, the dissipation system 110 can have other arrangements, including more, fewer, and/or different elements. For example, the conductive element 120 can be used without the base element 140 and/or the protective element 130. In certain embodiments where the conductive element is durable enough for intended vehicle operations without a protective element, the dissipation system does not include a protective element. In other embodiments, the elements can be arranged differently. For example, the conductive element can be partially or fully embedded or encased within the protective element or within the base element. In still other embodiments, at least a portion of the conductive element can be exposed on the outer surface of the protective element and/or the base element. In yet other embodiments, one or more portions or elements of the dissipation system can be operationally or electrically coupled to a ground plane via other arrangements. For example, the conductive element can be electrically coupled to a ground plane via a wire lead or connection.

In still other embodiments, the conductive element 120 can be coupled directly to, integral with, embedded in, and/or contained within the receiving surface. For example, FIG. 7 is a partially schematic cross-sectional elevation view of an electromagnetic dissipation system 710 in accordance with other embodiments of the invention. In FIG. 7, the dissipation system 710 includes a conductive element 720, similar to the conductive element discussed above with reference to FIGS. 1-6. The conductive element 720 is embedded in and/or carried by a receiving surface 702 similar to the receiving surface discussed above with reference to FIGS. 1-6. A protective element 730, similar to the protective element discussed above with reference to FIGS. 1-6, is coupled to a portion of the receiving surface 702 and/or the conductive element 720 so that the protective element 730 covers at least a portion of the conductive element 720.

In the illustrated embodiment, a fastener 708 is coupled to and/or proximate to the dissipation system 710 and is coupled to a conductive portion 706 (e.g., a spar) associated with the receiving surface 702. In FIG. 7, the conductive portion 706 serves as a portion of a ground plane. Accordingly, the fastener serves as a first dissipation point 704a associated with the receiving surface 702 and functions in a manner similar to the dissipation points discussed above with reference to FIGS. 1-6. Additionally, a conductive pathway 770 (e.g., an electrical connector or wire) provides a second dissipation point 704b associated with the receiving surface and is coupled to the conductive portion 706. In FIG. 7, the conductive pathway provides an electrical path between the conductive element 720 of the dissipation system 710 and the conductive portion 706 associated with the receiving surface. Accordingly, the second dissipation point 704b functions in a manner similar to the dissipation points discussed above with reference to FIGS. 1-6.

A feature of at least some of the embodiments described above is that a modular dissipation system, for example, in the form of a tape-like unit, can be produced and installed on portions of an aerospace vehicle where static electricity is expected to accumulate. Once installed, the dissipation system can dissipate selected static electrical charges that accumulate with little or no adverse effect to the vehicle or the dissipation system. An advantage of this feature is that the modular dissipation system can be easy to install. Additionally, a feature of some of the embodiments discussed above is that the dissipation system can have low observable characteristics and be durable, whether the system is installed as a modular unit or built into a receiving surface of a vehicle. An advantage of this feature is that the dissipation system can provide P-static dissipation, and be maintained more easily and cheaply than with current spray on coatings.

The above-detailed embodiments of the invention are not intended to be exhaustive or to limit the invention to the precise form disclosed above. Specific embodiments of, and examples for, the invention are described above for illustrative purposes, but those skilled in the relevant art will recognize that various equivalent modifications are possible within the scope of the invention. For example, whereas steps are presented in a given order, alternative embodiments may perform steps in a different order. The various aspects of embodiments described herein can be combined and/or eliminated to provide further embodiments. Although advantages associated with certain embodiments of the invention have been described in the context of those embodiments, other embodiments may also exhibit such advantages. Additionally, not all embodiments need necessarily exhibit such advantages to fall within the scope of the invention.

Unless the context clearly requires otherwise, throughout the description and the claims, the words “comprise,” “comprising,” and the like are to be construed in an inclusive sense as opposed to an exclusive or exhaustive sense, i.e., in a sense of “including, but not limited to.” Additionally, the words “herein,” “above,” “below,” and words of similar import, when used in this application, shall refer to this application as a whole and not to any particular portions of this application. Use of the word “or” in reference to a list of items is intended to cover a) any of the items in the list, b) all of the items in the list, and c) any combination of the items in the list.

In general, the terms used in the following claims should not be construed to limit the invention to the specific embodiments disclosed in the specification unless the above-detailed description explicitly defines such terms. In addition, the inventors contemplate various aspects of the invention in any number of claim forms. Accordingly, the inventors reserve the right to add claims after filing the application to pursue such additional claim forms for other aspects of the invention.

I/we claim:

1. An electromagnetic dissipation system, comprising:
a conductive material;
a protective element having an outer surface and an inner surface at least approximately opposite the outer surface of the protective element; and
a base element having an outer surface and an inner surface at least approximately opposite the outer surface of the base element, a portion of the inner surface of the protective element being positioned to at least approximately face a portion of the inner surface of the base element, the conductive material being coupled between the portion of the outer surface of the protective element and the portion of the outer surface of the base element to form a modular dissipation system that is attachable to a receiving surface with the portion of the outer surface of the base element at least approximately facing the receiving surface, the electromagnetic dissipation system being couplable to a ground plane and configured to dissipate static electricity proximate to the outer surface of the protective element to the ground plane when the electromagnetic dissipation system is coupled to the ground plane.

2. The system of claim 1, further comprising a low conductance carrier element, the conductive material being combined with the carrier element, the carrier element and conductive material being coupled between the portion of the outer surface of the protective element and the portion of the outer surface of the base element.

3. The system of claim 1 wherein the conductive material includes a conductive polymer.

4. The system of claim 1 wherein the conductive material includes at least one of carbon black, polyaniline, and polypyrrole.

5. The system of claim 1 wherein the base element includes an adhesive configured to attach the dissipation system to the receiving surface.

6. The system of claim 1 wherein the protective element includes at least one of polyurethane and a urethane elastomer.

7. The system of claim 1 wherein the outer surface of the protective element is configured to have low reflectivity with respect to a selected frequency of electromagnetic radiation.

8. The system of claim 1, further comprising a low conductance carrier element wherein the carrier element includes a nylon fabric, the conductive material being combined with the carrier element, the carrier element and conductive material being coupled between the portion of the outer surface of the protective element and the portion of the outer surface of the base element.

9. The system of claim 1 wherein the dissipation system is configured to dissipate a selected static electrical charge through a dissipation point associated with the receiving surface to the ground plane via at least part of the conductive element when the dissipation system is attached to the receiving surface without an adverse effect to the receiving surface, the dissipation point, or the dissipation system.

10. The system of claim 1 wherein the dissipation system is configured to dissipate a selected static electrical charge from part of the outer surface of the protective element through a dissipation point associated with the receiving surface to the ground plane via at least part of the conductive element when the dissipation system is attached to the receiving surface without direct contact between the dissipation point and the at least part of the conductive element and without an adverse effect to the receiving surface, the dissipation point, or the dissipation system.

11. The system of claim 1 wherein the dissipation system is at least approximately invisible to at least one selected frequency range of electromagnetic radiation.

12. A method for making an electromagnetic dissipation system, comprising:
providing a conductive material;
providing a protective element having an outer surface and an inner surface at least approximately opposite the outer surface of the protective element;
providing a base element having an outer surface and an inner surface at least approximately opposite the outer surface of the base element; and
coupling the conductive material between a portion of the outer surface of the protective element and a portion of the outer surface of the base element with the portion of the inner surface of the protective element positioned to at least approximately face the portion of the inner surface of the base element to form a modular dissipation system that is attachable to a receiving surface with the portion of the outer surface of the base element at least approximately facing the receiving surface, the electromagnetic dissipation system being configured to be couplable to a ground plane and configured to dissipate static electricity proximate to the outer surface of the protective element to the ground plane when the electromagnetic dissipation system is coupled to the ground plane.

13. The system of claim 12, further comprising:
providing a low conductance carrier element;
combining the conductive material with the carrier element; and
coupling the carrier element and conductive material between the portion of the outer surface of the protective element and the portion of the outer surface of the base element.

14. The system of claim 12, further comprising:
pressing a forming material having a selected surface roughness onto at least part of an outer surface of the protective element to configure the at least part of the outer surface to have low reflectivity with respect to a selected frequency of electromagnetic radiation; and
removing the forming material from the at least part of the outer surface of the protective element.

15. The system of claim 12 wherein the base element includes an adhesive configured to attach the dissipation system to the receiving surface.

16. A vehicle system, comprising:
a vehicle having a receiving surface and a ground plane;
a conductive element that includes a low conductance carrier element combined with a conductive material that includes a conductive polymer; and
a protective element having an outer surface and an inner surface at least approximately opposite the outer surface of the protective element, a portion of the inner surface of the protective element being positioned to at least approximately face a portion of the receiving surface of the vehicle, the conductive element being at least one of (a) coupled between the portion of the receiving surface of the vehicle and the portion of the outer surface of the protective element, and (b) embedded in the portion of the receiving surface, the electromagnetic dissipation system being operably coupled to the ground plane and configured to dissipate static electricity proximate to the outer surface of the protective element to the ground plane.

17. The system of claim 16, further comprising a base element coupled between the conductive element and the receiving surface of the vehicle.

18. The system of claim 16 wherein:
the carrier element includes a nylon fabric;
the conductive material includes at least one of carbon black, polyaniline, and polypyrrole; and
the protective element includes at least one of polyurethane and a urethane elastomer.

19. The system of claim 16 wherein the protective element includes an outer surface configured to have low reflectivity with respect to a selected frequency of electromagnetic radiation.

20. The system of claim 16 wherein the conductive element is configured to dissipate a selected static electrical through a dissipation point associated with the receiving surface and the ground plane without an adverse effect to the vehicle system.

21. The system of claim 16 wherein the conductive element is configured to dissipate a selected static electrical charge from part of the outer surface of the protective element through a dissipation point associated with the receiving surface and the ground plane without direct contact between the dissipation point and the at conductive element and without an adverse effect to the vehicle system.

22. The system of claim 16 wherein the conductive element and the protective element are at least approximately invisible to at least one selected frequency range of electromagnetic radiation.
